(19) United States
(12) Patent Application Publication
(10) Pub. No.: US 2013/0068892 A1
(43) Pub. Date: Mar. 21, 2013

(54) FLYING APPARATUS FOR AERIAL AGRICULTURAL APPLICATION

(71) Applicants: Hazry Bin Desa, Perlis (MY); Muhamad Firdaus Bin Muhamad Dali, Perlis (MY); Mohd Zahiruddin Bin Dzulkifli, Perlis (MY); Zul Azfar Bin Ahmam, Perlis (MY)

(72) Inventors: Hazry Bin Desa, Perlis (MY); Muhamad Firdaus Bin Muhamad Dali, Perlis (MY); Mohd Zahiruddin Bin Dzulkifli, Perlis (MY); Zul Azfar Bin Ahmam, Perlis (MY)

(21) Appl. No.: 13/701,503

(22) PCT Filed: Jun. 3, 2011
(86) PCT No.: PCT/MY2011/000067

§ 371 Date: Dec. 1, 2012

(30) Foreign Application Priority Data
Jun. 4, 2010 (MY) PI2010002587

(51) Int. Cl. B64D 1/18; B64C 19/00; B64D 47/08; B64C 13/20; B64C 39/02

(52) U.S. Cl. 244/190; 701/4; 701/3

(57) ABSTRACT

A remotely controlled flying apparatus (200) utilized for crop-spraying and crop monitoring purposes is disclosed. The present indention comprises a microcontroller (110) electronically coupled to an inertia measuring means (120). A controller (140) is connected to a computer (130) to allow a user to control movements of the flying apparatus (200). The computer (130) interprets control motions of the controller (140) and translates the motions to control signals. Upon translation, control signals are sent to the microcontroller (110) wirelessly and the control signals are modulated by a pulse modulation generator (150) before they are sent to a plurality of speed controllers (160a-160d) which are coupled to a plurality of motors (170a-! 70d). The controller (140) allows the user to control the motions of the flying apparatus remote! }, by changing respective rotational speeds of the plurality of motors (170a-170d). The controller (140) also allows the user to wirelessly control a pump (180) or a camera (190) or both through the computer (130) for spraying a pesticide or fertilizer fluid—when necessary or for crop monitoring purposes.

### FIELD OF INVENTION

The present invention relates to a flying apparatus for aerial agricultural application. More particularly, this invention relates to a semi-autonomous and remotely controlled multiple rotor aircraft for crop-spraying and crop monitoring purposes.

### BACKGROUND OF THE INVENTION

Aerial application for crop-spraying or crop-dusting purposes has been commonly applied with the usage of fertilizers, pesticides and fungicides from an aircraft, usually an airplane drivable by a pilot. Spraying of fertilizers is necessary to ensure healthy growth of crop while pest control is necessary to maximize food production by keeping the crops free from pests. It is also advantageous to protect crops from competing species of plants.

Prior to the usage of aircraft, pest control is done conventionally by burning or plowing weeds and to kill crows and other birds. Numerous techniques are applied such as crop rotation, companion planting and selective breading of pest-resistant cultivars. Beside that, pest control and fertilizing of plants are also achievable by manual spraying. Manual steps become the substitute of an aircraft when purchasing an aircraft is unnecessary for small plantations or when cost is a constraining factor.

Additionally, disease management, crop maturity monitoring and intrusion monitoring is achieved by manual visual inspection, wherein farmers would determine the maturity and the condition of the crops by inspecting the crops at the plantations to determine the appropriate time to harvest the crops. Nevertheless, such inspection requires a substantial amount of time and is laborious, even more so if the plantation site covers a substantially large area. Manual visual inspection are also prone to mistakes and may potentially impact the yield of crops.

A number of prior arts have disclosed the usage of aircraft for crop-spraying or crop-dusting and the usage of such aircraft is common practice in the plantation industry. One such prior art is disclosed by international application publication WO 93/15955. The prior art mentioned the usage of an apparatus for crop spraying or crop assessment operations which includes monitoring means to sense thermal differentials, crop spraying means and crop assessment means for sensing wetted areas of crop which are preferably attached to an aircraft. Camera are also attached to the aircraft so as to allow the pilot to monitor the crops from the cockpit. However, such aircraft is large in size and most likely high in cost which would not be practical to be used in smaller plantations or when cost is an issue. Aircraft also requires a runaway for take off and landing, which would take up unnecessary space in a plantation.

Similarly, U.S. Pat. No. 5,025,988 and U.S. Pat. No. 2,941,753 disclosed the usage of an aircraft for aerial spraying of crops. The former discloses a drivable aircraft which is again, not cost effective while the latter discloses an aircraft that may be remotely controlled for crop spraying purposes. Nevertheless, the latter uses a helicopter, thus implying less degree of control for the user since a helicopter of the prior art is merely driven by a single rotor. This would impair the degree of freedom of the aircraft, which would mean that crop spraying is only achievable by a systematic approach, thus rendering spot spraying of crops unachievable.

Therefore, there is a need for a flying apparatus for crop-spraying and crop monitoring that is semi-autonomous and remotely controlled to overcome the above disadvantages.

### SUMMARY OF INVENTION

Accordingly, it is a primary object of the present invention to provide a flying apparatus for crop spraying and crop monitoring purposes.

It is another object of the present invention to provide a flying apparatus for crop spraying and crop monitoring purposes that is semi-autonomous and remotely controlled.

It is yet another object of the present invention to provide a flying apparatus for crop spraying and crop monitoring purposes that has multiple motor and propellers to allow for a higher degree of freedom and control.

It is further another object of the present invention to provide a flying apparatus for crop spraying and crop monitoring purposes that is cost effective.

To fulfill the aforementioned objectives, a remotely controlled flying apparatus otherwise known as a ‘quadrotor’ is utilized for crop-spraying and crop monitoring purposes. In a preferred embodiment, the flying apparatus comprises a microcontroller electronically coupled to an inertia measuring means. A joystick is connected to a computer to allow a user to control movements of the flying apparatus. The computer interprets control motions of the joystick and translates the motions to control signals. Upon translation, control signals are sent to the microcontroller wirelessly and the control signals are modulated by a pulse modulation generator before they are sent to a plurality of speed controllers which are coupled to a plurality of motors. The joystick allows the user to control the motions of the flying apparatus remotely by changing respective rotational speeds of the plurality of motors through the plurality of speed controllers. The rotational speed of the plurality of motors, coupled to a plurality of propellers would determine the amount of downward air thrust. The joystick also allows the user to wirelessly control a pump or a camera or both through the computer for spraying a pesticide or fertilizer fluid when necessary or for crop monitoring purposes.

Additionally, the microcontroller which is electronically coupled to the inertia measuring means, collects the tilt data from the inertia measuring means to semi-autonomously control the balancing of the flying apparatus when elevated and also sends relevant data to the computer for the user.

In another preferred embodiment, the joystick also allows the user to manipulate the camera which is wireless and may be incorporated with a thermal detection feature to detect the level of soil toxicity or to generate real time visuals of the crops.

To control the motion of the flying apparatus, rotational speeds of the plurality of motors are manipulated thus changing the speeds of the propellers. Changing the speeds of respective motors will cause different directional movements and thus allow a higher degree of control by the user.

The present preferred embodiments of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

These and other features, aspects and advantages of the present invention will be more fully understood when considered with respect to the following detailed descriptions, appended claims and accompanying drawings wherein:

FIG. 1 is a system diagram of a flying apparatus;

FIG. 2 is a perspective view of a basic embodiment of the flying apparatus;

FIG. 3 is a diagram of a guidance, navigation and control (GNC) system of the flying apparatus;

FIG. 4 is a diagram showing a technique to control the motion of the flying apparatus;

FIG. 5 is a perspective view of an alternative basic embodiment of the flying apparatus; and

FIG. 6 is the alternative basic embodiment viewed from the bottom.

### DETAILED DESCRIPTION OF THE INVENTION

The present invention relates to a flying apparatus for aerial agricultural application. More particularly, this invention relates to a semi-autonomous and remotely controlled multiple rotor aircraft for crop-spraying and crop monitoring purposes.

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

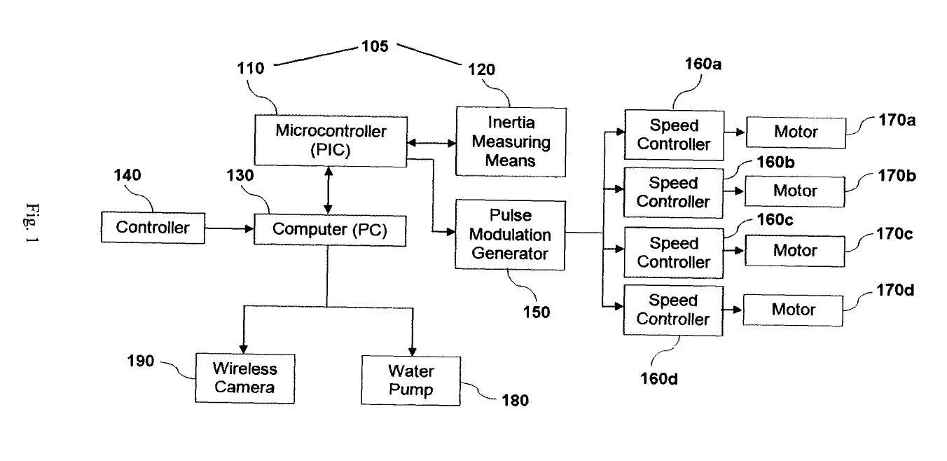

Referring to FIG. 1, there is shown a system diagram of a flying apparatus (200) for crop-spraying and crop monitoring purposes comprising a control means (105) and a controller (140) which is preferably a joystick, connected to a computer (130) to allow a user to control movements of the flying apparatus (200). The control means (105) comprises a microcontroller (110) electronically coupled to an inertia measuring means (120). The computer (130) interprets control motions from the controller (140) and translate the control motions to control signals which are then sent wirelessly to the microcontroller (110). The microcontroller (110) is connected to a pulse modulation generator (150) which modulates the control signals and send the modulated control signals to a plurality of speed controllers (160a-160d) which are coupled to a plurality of motors (170a-170d). In a preferred embodiment, the motors (170a-170d) are preferably brushless motors. The controller (140) allows the user to control the motions of the flying apparatus (200) remotely by moving the controller (140) which then changes the control signals and subsequently, respective rotational speeds of the plurality of motors (170a-170d) through the plurality of speed controllers (160a-160d). The controller (140) also allows the user to wirelessly control a pump (180) through the computer (130) for spraying a pesticide or fertilizer fluid when necessary.

Still referring to FIG. 1, the controller (140) also allows the user to manipulate at least one camera (190), mountable to the flying apparatus (200). In a preferred embodiment, the camera (190) may be wireless and may be incorporated with a thermal detection feature to detect the level of soil toxicity that is pivotal to determine crops that are potentially affected by major diseases. However, in another preferred embodiment, the camera (190) may be used solely to generate real time visuals of the crops for determination of crop maturity and pests intrusion.

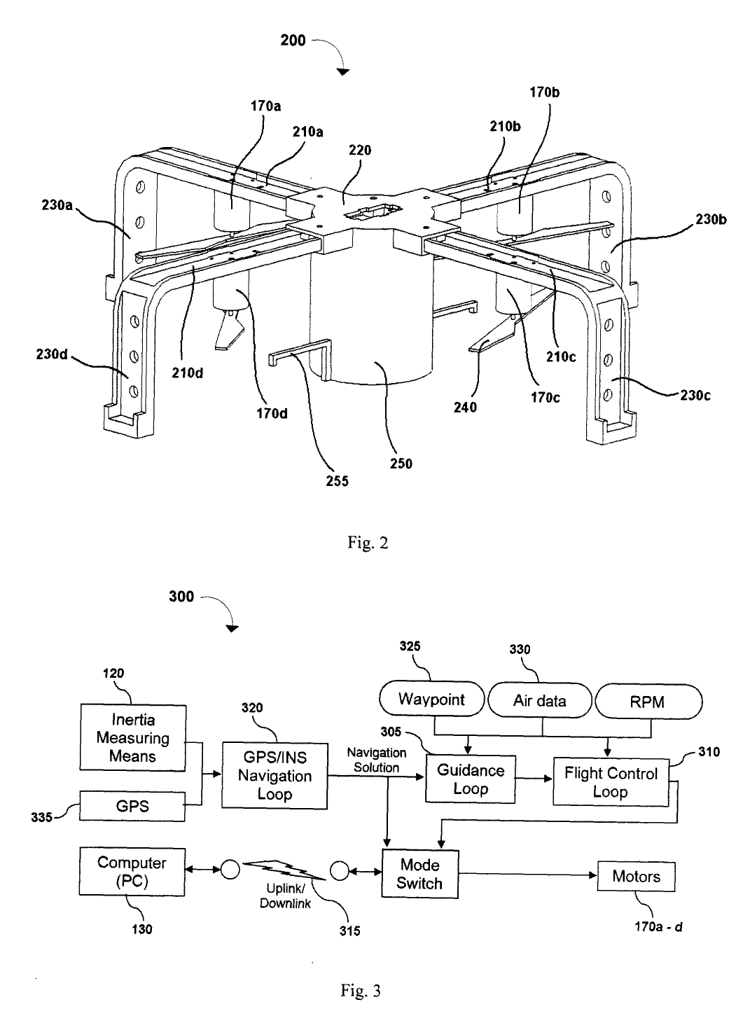

Referring now to FIG. 2, there is shown a perspective view of a basic embodiment of the flying apparatus (200). The basic embodiment of the flying apparatus (200) comprises the plurality of motors (170a-170d) with each of the motors (170a170d) being mounted to an arm (210a-210d). The arms (210a-210d) extends from a connector (220), located at the middle of the flying apparatus (200) and have equal lengths. The plurality of arms (210a-210d) are arranged in such a way that each consecutive arms (210a-210d) are equally spaced apart. The motors (170a-170d) are mounted along the arms (210a-210d), preferably by screws or bolts, with each of the motors (170a-170d) being placed at an equal distance from the middle of the flying apparatus (200). In the preferred embodiment, each arms (210a-210d) extends and bends downwardly, preferably perpendicularly to form a plurality of supporting legs (230a-230d). Each motors (170a-170d) are mechanically coupled to a propeller (240) to control the movement of the flying apparatus (200). The flying apparatus (200) also comprises a tank (250) that is mountable to the connector (220) at the middle of the flying apparatus (200). The tank (250) is accommodate with a plurality of sprayers (255) at the periphery of the tank (250). A water pump (not shown) is preferably provided within the tank (250) to pump fluid in the tank (250) to be released as dispersed droplets from the plurality of sprayers (255).

In the preferred embodiment, the plurality of motors (170a-170d) and the plurality of propellers (240) are facing downwards as seen in FIG. 2 to achieve a downward air thrust but the plurality of motors (170a-170d) and the plurality of propellers (240) may be arranged to face upwards, similar to a quadrotor helicopter.

In a preferred embodiment, the plurality of arms (210a-210d) and the connector (220) may be fabricated from polymeric or thermoplastic materials such as polyfoam or acrylonitrile butadiene styrene (abs) to keep the flying apparatus (200) lightweight for better elevation.

Still referring to FIG. 2, the control means (105) and the pulse modulation generator (150) are accommodated on the other side of the connector (220), opposite to the tank (250). In reference to FIG. 2, the control means (105) and the pulse modulation generator (150) would be accommodated on the upper side of the connector (220).

The inertia measuring means (120) senses the motion of the flying apparatus (200) such as tilt, type, rate and direction of its motion using a combination of accelerometers and gyroscopes. Detection of the flying apparatus's (200) rate of acceleration and change in rotational attributes which are pitch, roll and yaw are continuously and wirelessly fed to the computer (130) via the microcontroller (110) to calculate current speed and position of the flying apparatus (200), given a known initial speed and position. Such features allow the user to determine the location and the rate of movement of the flying apparatus (200). In a preferred embodiment, the inertia measuring means (120) is a MEMS inertial measurement unit (IMU).

Additionally, the microcontroller (110) which is electronically coupled to the inertia measuring means (120), collects the tilt data from the inertia measuring means (120) to semi-autonomously control the balancing of the flying apparatus (200) when elevated.

In another preferred embodiment, the inertia measuring means (120) is incorporated with a global positioning system (GPS) (335) to enable real time navigation of the flying apparatus (200) as can be seen in FIG. 3. This thus allows the present invention to employ a GPS/Inertial Navigation System (INS) navigation loop (320) that provides continuous and reliable navigation solutions to guide and control the flying apparatus for autonomous flight. According to a guidance, navigation and control (GNC) system (300) of the present invention as can be seen in FIG. 3, additional data (330) allows a guidance loop (305) to compute guidance demands to emulate waypoint (325) scenarios. A flight control loop (310) generates actuator signal for control surfaces and thrust vector. The GNC system (300) is embedded within the computer (130). In a remote operation mode, the control signals is sent to the plurality of motors (170a-170d) via a wireless uplink channel (315). The GPS/INS navigation loop (320) downlinks the flying apparatus (200) states to the computer (130) for monitoring purposes. Upon activation of an autonomous mode, navigation solution is fed into the guidance loop (305) and the flight control loop (310) to redirect a computed control output to the plurality of motors (170a-170d).

The GPS/INS navigation loop (320) utilizes a four-sample quaternion algorithm for attitude update. A complementary Kalman filter is designed with errors in position, velocity and attitude being the filter states. The Kalman filter estimates low-frequency errors of the INS by observing GPS data with noises. In actuality, a U/D factorized filter is used to improve numerical stability and computational efficiency. With high maneuvarability, part of the GPS antenna may be blocked from satellite signals which causes a receiver to operate in two dimensional height-fixed mode. Therefore, to maximize satellite visibility, a second redundant receiver is preferably installed.

The guidance loop (305) generates guidance commands from different states of the flying apparatus (200) and corresponding waypoint (325) information. The guidance loop (305) computes required speed with respect to air, height and bank angle. The flight control loop (310) generates control signals for the plurality of motors (170a-170d) in stabilization and guidance of the flying apparatus (200).

The navigation loop (320) produce navigation outputs that are used in guidance and control of the flying apparatus (200) together with providing precise timing synchronization to other sensor nodes. The INS and Kalman filter of the navigation loop (320) provides continuous and reliable position, velocity and attitude of the flying apparatus (200) with high rates and estimates navigation errors by blending GPS observation as background task respectively.

The INS is mechanised in an earth-fixed tangent frame by computation of position, velocity and attitude of the flying apparatus (200) with respect to the reference frame by numerical integration of accelerations and angular rates. The reference frame is assumed to be a non-rotating inertial frame. With short flight time and high frequency of GPS corrections, the assumption is valid without significant performance degradation in most of the local terrestrial navigators.

In the preferred embodiment, the control signal is of the radio control (RC) type and is modulated by Pulse Position Modulation (PPM) by the pulse modulation generator (150) prior to sending the signal to the plurality of speed controllers (160a-160d). PPM has the advantage of requiring constant transmitter power since pulses are of constant amplitude and duration.

In the preferred embodiment, the tank (250) with a plurality of sprayers (255) on its periphery, being mountable to the connector (220), is used for spraying pesticides or fertilizers. However, the tank (250) is removable, and may be replaced with the camera (190) as seen in FIG. 1. The camera (190) is similarly mountable to the connector (220) and is utilized for crop maturity monitoring, pest intrusion monitoring and disease management. In another embodiment, the tank (250) and the camera (190) are both simultaneously mountable to the connector (220) to allow both spraying of pesticides or fertilizers and crop maturity and pests intrusion monitoring.

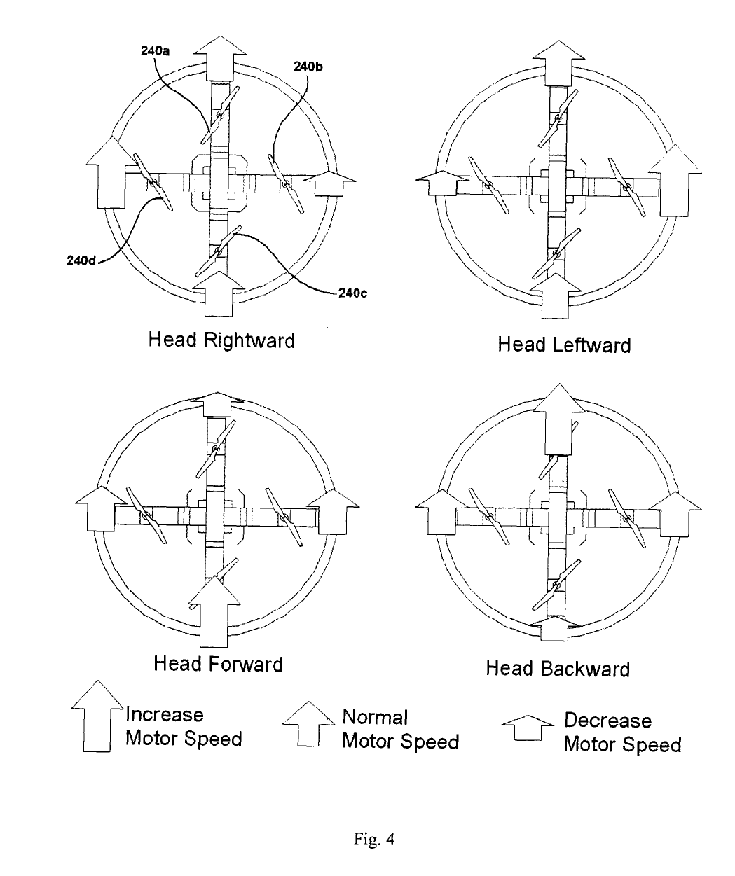

Referring now to FIG. 4, there is shown a plurality of technique for control of the motion of the flying apparatus (200). The description of the direction henceforth is in reference to FIG. 4. The basic motion of the flying apparatus (200) as can be seen in FIG. 4 are rightward, leftward, forward and backward. The utilization of the plurality of propellers (240) allows the flying apparatus (200) to land and take-off vertically or better known as a “Vertical and/or Short Take-Off and Landing (V/STOL)” aircraft. Motion of the flying apparatus (200) may be controlled by manipulation of the rotational speed of the propellers (240) which is determined by the plurality of motors (170a-170d).

To have the flying apparatus (200) head rightward, the left propeller (240d) is controlled to have a higher rotational speed than the right propeller (240b). This would cause a net linear speed to the right, encouraging the flying apparatus (200) to head rightward. In a same manner, to head leftward, the right propeller (240b) is controlled to have a higher rotational speed than the left propeller (240d).

To have the flying apparatus (200) head forward, the back propeller (240c) is controller to have a higher rotational speed than the front propeller (240a). This would cause a net linear movement forward. In a same manner, to head backward, the front propeller (240a) is controlled to have a higher rotational speed than the back propeller (240c).

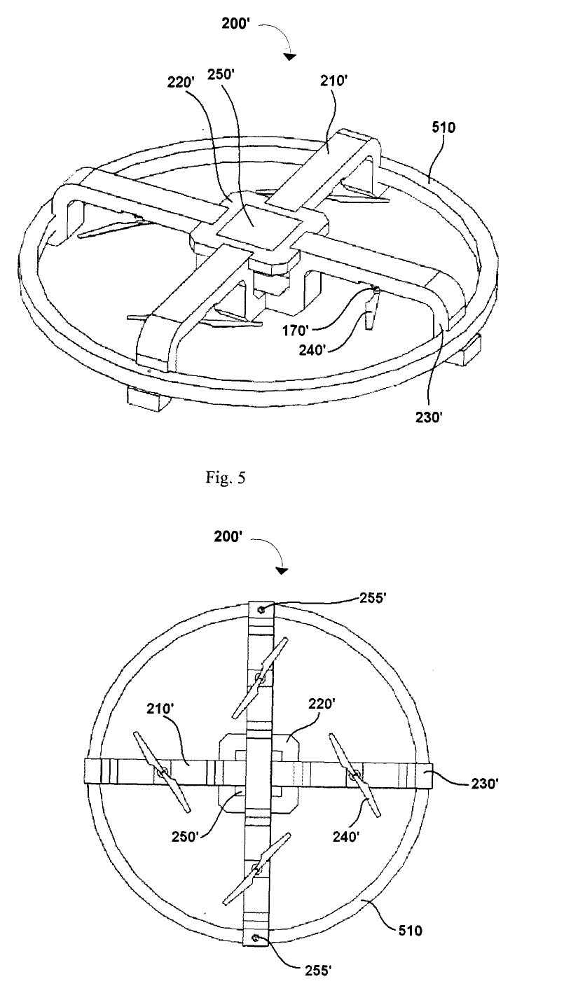

In an alternative basic embodiment of the invention as can be seen in FIG. 5, the flying apparatus (200′) comprises a plurality of arms (210′) that extends from a connector (220′) and bends downwardly to form a plurality of legs (230′), a plurality of motors (170′) coupled to a plurality of propellers (240′) mounted along the plurality of arms (210′) and a tank (250′) that may be mounted to the connector (220′). The alternative basic embodiment further comprises a supporting member (510) that preferably connects the plurality of legs (230′). The supporting member (510) in the alternative embodiment is circular in shape. A plurality of sprayers (255′) of the alternative embodiment is connected to the tank (250′) and is preferably embedded within the plurality of arms (210′) as shown in FIG. 6, which is a bottom view of the alternative basic embodiment shown in FIG. 5.

Although this disclosure has described and illustrated certain preferred embodiments of the invention, it is to be understood that the invention is not restricted to those particular embodiments. Rather, the invention include all embodiments which are functional or mechanical equivalence of the specific embodiments and features that have been described and illustrated.

1. A flying apparatus for aerial agricultural application, comprising;
a control system;
a plurality of arms that extend from a connector located at a middle section of the flying apparatus wherein the plurality of arms bend downwardly to form a plurality of supporting legs;
a plurality of motors each coupled to a propeller, each motor being mounted along one of the arms; and
a tank mountable on the connector with a plurality of sprayers at its periphery for releasing dispersed droplets of a fluid contained within the tank;
wherein the control system receives wireless control signals to control the motion of the flying apparatus by changing the speeds of the motors and also to control the release of dispersed droplets of the fluid.

2. The flying apparatus according to claim 1, further comprising at least one camera mountable to the connector.

3. The flying apparatus according to claim 1, further comprising a supporting member that connects the plurality of legs.

4. The flying apparatus (200) according to claim 2, wherein the camera is incorporated with a thermal detection feature to detect a level of soil toxicity.

5. The flying apparatus (200) according to claim 1, further comprising a pulse modulation generator which modulates the control signals and sends the modulated signals to a plurality of speed controllers to change the speed of the plurality of motors.

6. The flying apparatus according to claim 1, wherein the control system comprises a microcontroller electronically coupled to an inertia measuring system wherein the microcontroller balances the flying apparatus based on tilt data measured by the inertia measuring system.

7. The flying apparatus (200) according to claim 5, wherein the flying apparatus is incorporated with a global positioning system (GPS) to enable real time navigation of the flying apparatus.

8. The flying apparatus (200) according to claim 1, wherein the control signals are generated by a computer that interprets corresponding control motions of a controller and translates the control motions to control signals.

9. The flying apparatus (200) according to claim 1, wherein the control signals are radio control (RC) signals.

10. The flying apparatus according to claim 1, wherein the plurality of arms, the plurality of legs and the connector are fabricated from polymeric materials.
